(19) United States
(12) Patent Application Publication
(10) Pub. No.: US 2011/0075285 A1
(43) Pub. Date: Mar. 31, 2011

(54) HOUSING ELEMENT FOR A REAR VIEW MIRROR

(75) Inventor: Dirk Mueller, Stuttgart (DE)

(73) Assignee: SMR Patents S.a.r.l., Luxembourg (LU)

(21) Appl. No.: 12/895,029

(22) Filed: Sep. 30, 2010

(30) Foreign Application Priority Data
Sep. 30, 2009 (EP) 09171880

(51) Int. Cl. G02B 7/182

(52) U.S. Cl. 359/872

(57) ABSTRACT

The invention provides a part of the mirror housings or cover that has a designed-in-flexibility to move versus other cover parts and to move back to the working position without distortions.

### BACKGROUND ART

1. Field of the Invention

The invention is based on a priority patent application EP 09171880.9 which is hereby incorporated by reference.

The invention discloses a solution for a rear view mirror with cover elements. The inventional rear view mirror has cover elements that allows other cover elements to move and has a built in flexibility to allow the mirror to fold away from driving position.

2. Description of the Related Art

Rear view mirror for vehicles is designed with two main parts: the mirror base and the mirror head. These two main parts of a rear view mirror assembly are covered with plastic elements for a nice appearance and a reduction of turbulent air flow. In addition the cover elements smooth the rigid edges of the functional parts and reduce the risk for persons colliding with a rear view mirror.

It is also known to combine the functional elements of a rear view mirror with the covers as in molding mirror bases in plastic so that they appear with a smooth surface.

For security reasons rear view mirrors pass a security test according ECE regulations for example. In these tests the impact of a pedestrian's head is simulated and the rear view mirror must hinge away with a dedicated force in traveling direction and against traveling direction of vehicle. Rear view mirrors that have a pivot axis that lays not in the plane of mirror head and mirror base cover joints. When the rear view mirror assembly is folded the cover elements move out of the pivot center and can block the movement. For this type of rear view mirror the security parameters will not be fulfilled and the rear view mirror would not be legally approved.

The problem of a mirror to be hinged away is described in U.S. Pat. No. 6,340,231 wherein an electrical actuator is used and has features to easily fold away for security reasons. U.S. Pat. No. 6,361,178 disclosed a rear view mirror attached to a bearing arm and a holding rod which pivot about the swivel axis in a plane extending in a direction substantially parallel to a direction of travel of the vehicle. The housings in the prior art are not blocking the pivot motion.

U.S. Pat. No. 4,712,891 discloses a solution where the rear view mirror is moulded in an undercut moulding process that combines a rigid material and a soft material. The core of the housing is made of a rigid material while the surface is made of a soft material. Both mirror head and mirror base have a part that is rigid and a surface part of an elastic material. If the mirror is folded versus the vehicle contour the two main parts of the minors pivot around an axis. The two parts of the mirror housing come into abutment. The forces when the components are in abutment compress the elastic parts of the mirror.

### SUMMARY OF THE INVENTION

The invention is shown in the figures and shortly described thereafter. The inventional solution is useful in designs wherein the housing parts of the rear view mirror could block the pivot motion or could break after an impact folding away the mirror. This would increase the risk to injure somebody and the invention gives a way to have a design with a smooth surface of a rear view mirror and the security aspect that the mirror is folded away without destroying parts.

The invention provides at least one part of the mirror housings or covers that has a designed-in-flexibility to move versus other cover parts and to move back to the working position without distortions.

### BRIEF DESCRIPTION OF THE DRAWINGS

FIG. 1 shows a rear view mirror

FIG. 2 a cross section of a rear view mirror

FIG. 3 show a design with housing elements

FIG. 4 show the design to provide flexibility

FIG. 5 shows details of the design

FIG. 6 shows the fold away positions of a mirror

FIG. 7 shows the housing elements in a fold back position.

FIG. 8 shows schematically a pivot axis for different designs.

FIG. 9 shows a mirror base allowing additional range of movement

### DETAILED DESCRIPTION OF THE PREFERRED EMBODIMENT

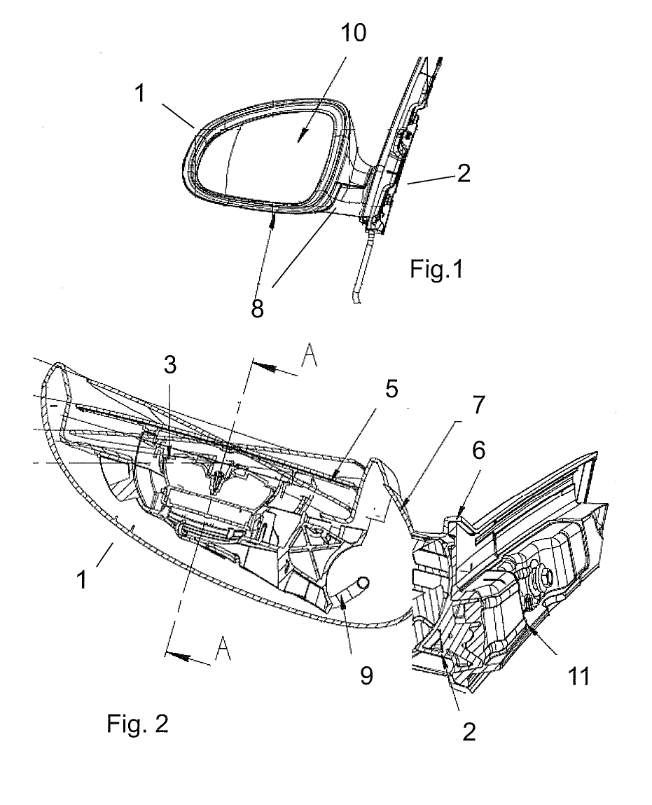

FIG. 1 shows a rear view mirror assembly as it is attached to a vehicle at the left side. A mirror base 2 is connected to a mirror head 1. The mirror head comprises a reflective element 10 for the rear view. The mirror head has an upper housing part 7 and a lower housing part that covers the technical elements of the mirror head.

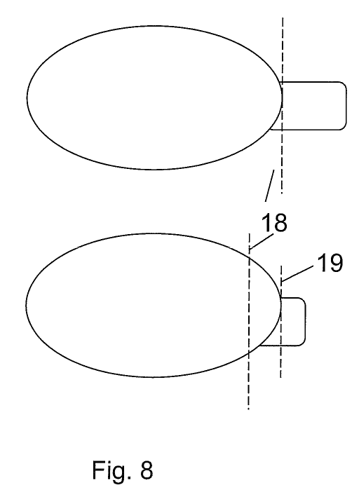

FIG. 8 discloses the problem with a pivot axis that does not fall into the plane of joint 19 between mirror base cover and mirror head cover. If the mirror head is folded in traveling direction of the vehicle the mirror head in this figure is moving out of the paper plane. In the upper scheme the cover of mirror head can pivot versus the base without problems. In the scheme below the mirror head cover distal end moves out of the paper plane and the end closer to the vehicle in the paper lane. The mirror head cover is blocked by mirror base cover. The pivot movement is blocked in rear view mirror examples that are designed to use a power fold actuator that works without lift of mirror head versus mirror base. If the mirror is hinged a movement only around an axis is realized. The design of mirror base and mirror head for the manual version is according the power fold versions.

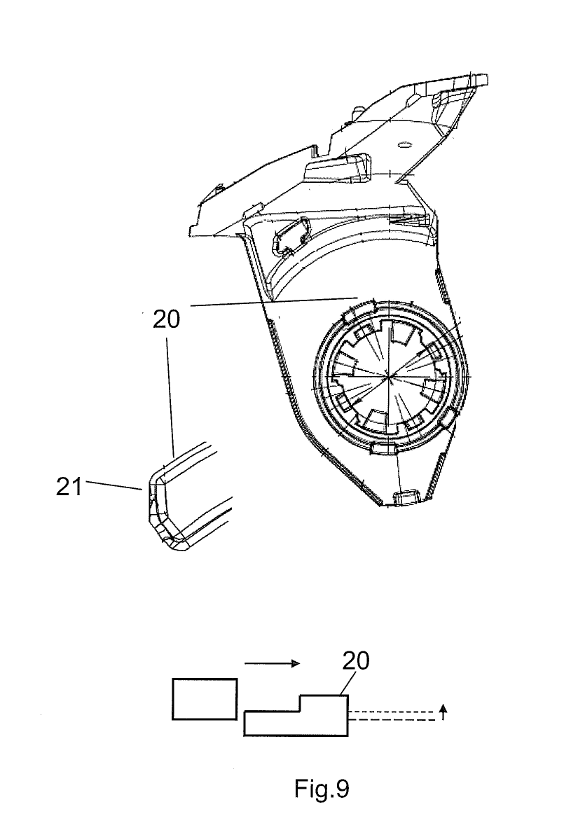

To avoid the blocking of mirror head the end stop design is also adapted to allow the mirror head to move over the end stop in the folding mechanism. For this purpose the end stop elements in the manual folding design has a structure with a first step for the normal fold back stop end and a second step for the final end stop before the mirror crashed at the vehicle's body. The two step solution of stop end cam 20 is schematically shown in FIG. 9.

The first step can be overridden by an impact as it is applied in the pendulum impact test. The overlap of the cams is only around 1 mm, so that an impact can move the blocking cam up, see arrow, and allow the pivotable means to slide over the surface of the cam. The additional distance is marked with an arrow too.

The power fold version as seen in FIG. 9 too has a stop end cam 20 with a phased face 21. The normal face is the first level of the stop end movement. With the impact the counter cam slides along the phased face and allows the additional movement. The phased face 21 allows the mirror to move the additional circle segment after blocking of cover is solved.

In FIG. 2 the rear view mirror assembly is shown in more details. The mirror head 1 is shown in a across section along the long axis. The upper hosing part 7 covers a glass actuator 3 that supports a glass support 5. The upper housing part 7 ends at the mirror base cover 6 that protects the mirror base 2. The mirror base has a sealing in direction to the vehicle.

A harness 9 connects the electrical devices with the vehicle board system. In another embodiment the mirror base is molded as one part in plastic and the mirror base cover is not necessary. In this application the mirror base cover includes a solution with a full plastic mirror base comprising the cover surface too.

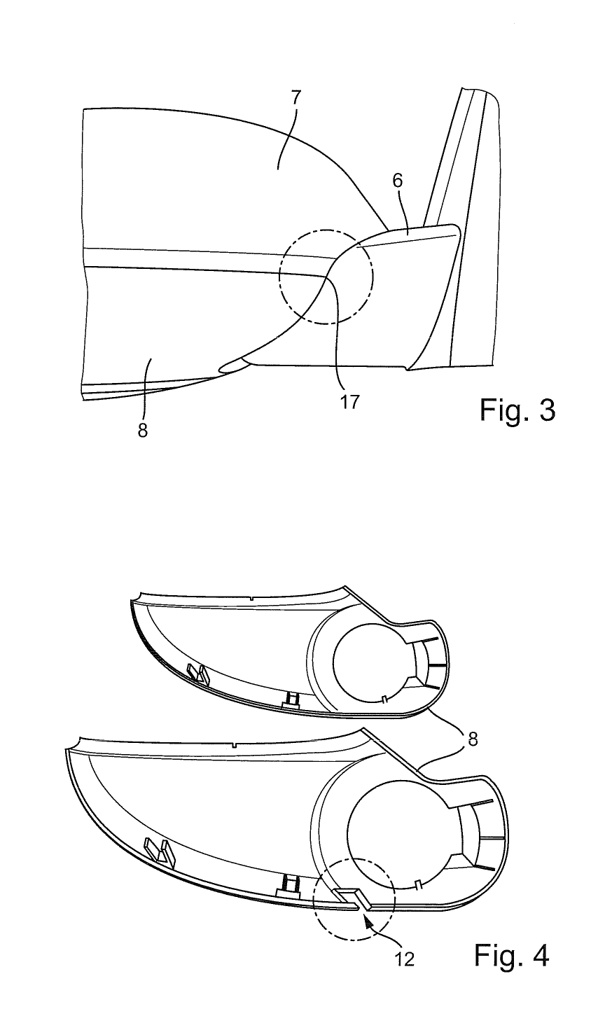

FIG. 3 shows an example of housings for a rear view mirror assembly, In this embodiment an upper housing part 7, a lower housing part 8 and a mirror base cover covers the technical elements of the mirror. A critical joint 17 is highlighted with a circle. At this point the three parts of housing are joined together. In the working position of the rear view mirror assembly as it is shown in FIG. 3 the housing parts join without a gap between the parts.

FIG. 4 shows a top view of the lower housing part 8 with the circle opening for the pivot axis of the mirror base. The upper version is a standard design, the design below in the figure shows the inventional solution to provide a flexible element for the lower housing part.

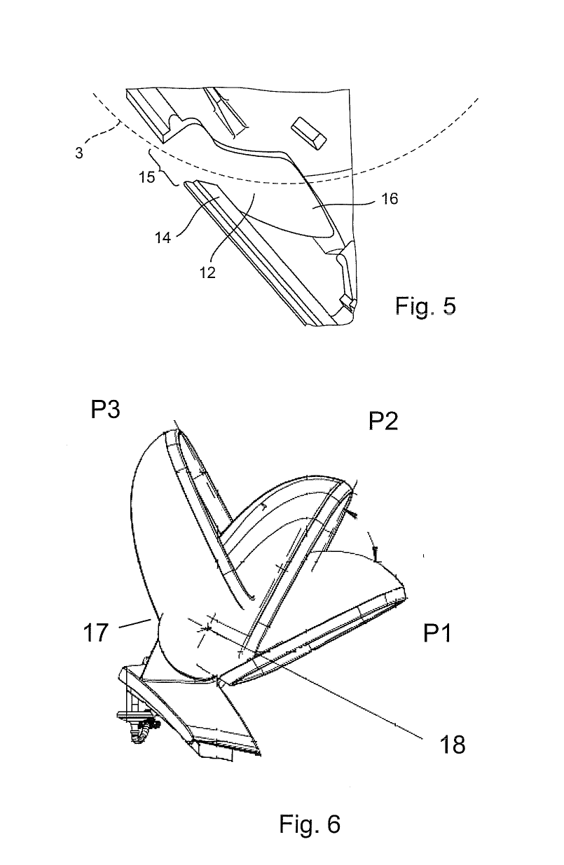

The detail of the solution is visible in FIG. 5. The lower housing part 8 has a clearance 12 in which another part of the housing can fit in if the mirror head is folded. The clearance 12 follows a circle path that is parallel to the opening for the pivot axis. The clearance has a direction along the circle motion of the mirror head versus the mirror base. The clearance 12 has a first opening width 12 and a second opening width 16. The opening width increases from the first to the second opening width. The clearance forms a small bar 14 at the inner end of the lower housing part 8. The whole housing is formed in a flexible material, a plastic as ABS for example. The material must have enough flexibility, so that the small bar can move slightly without breakage.

FIG. 6 shows the rear view mirror assembly in three positions. In the position P2 the mirror is installed in working position at the vehicle. The positions P1 shows the fold in version which is used if a power fold actuator folds in the mirror in a parking position. The same position is achieved in the pendulum impact test with an impact on the housing from the front of the mirror. Position P3 is the position that is realized after an impact from the rear side of the mirror. This is the critical position.

The housing part have to move against each others with the result that they cant.

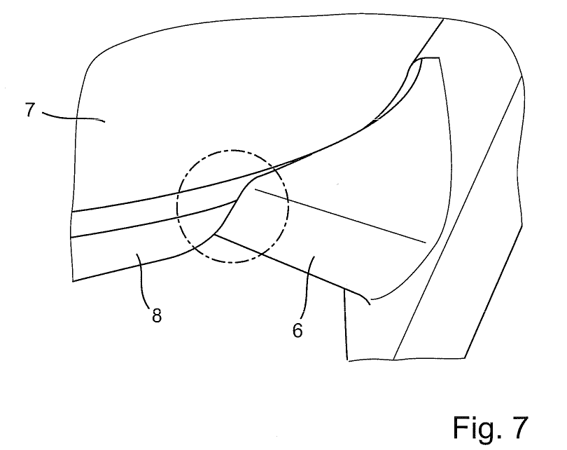

FIG. 7 shows the solution of the invention. The lower housing part 8 undercuts under the mirror base cover 6. The mirror base cover edge links into the clearance of the lower housing part 12 and move along the circle 13. The small bar 14 is spread away and a gap occurs between the housing parts.

The rear view mirror assembly doe not cant and move without distortion to the fold away position that is necessary for security reasons. The rear view mirror assembly is not disturbed, no parts of the mirror housing are breaking away resulting in sharp edges.

After impact the mirror head can be moved back into working position and the flexible bar 14 snaps back into the unstressed conditions.

### LEGEND

1 Support
2 Mirror Base
3 Glass Actuator
4 Power fold actuator
5 Glass support
6 Mirror base cover
7 Housing Upper part
8 Housing lower part
9 Harness
10 Reflective Element
11 Sealing
12 Clearance
13 Circle
14 Bar
15 First opening width
16 Second opening width
17 Joint
18 pivot axis
19 joint plane head and base
20 stop end cam
21 phased face

I claim:

1. A rear view mirror assembly with a mirror head and a mirror base at least two mirror housing parts covering the elements of the rear view mirror assembly, wherein the mirror head is pivotable mounted to the mirror base with an axis, characterized in that at least one part of the mirror housing parts that cover the rear view mirror assembly has a clearance in form of a notch so that at least two parts can undercut each others in case of rear view mirror folding out of working position in folded position.

2. A rear view mirror assembly according claim 1 characterized in that the clearance has the form of a segment of a circle following a path parallel to the opening of the pivot axis.

3. A rear view mirror assembly according claim 2 characterized in that the circle is along the circle of the pivot motion of mirror head versus mirror base.

4. A rear view mirror assembly according claim 1 characterized in that the clearance has a first opening width and a second opening width and the width is increasing from the first to the second width.

5. A rear view mirror assembly according claim 1 characterized in that the clearance forms a bar-shaped notch in the at least one housing part.

6. A rear view mirror assembly according claim 5 characterized in that the bar-shaped notch is flexible and can be moved outside the shape of the housing part.

7. A rear view mirror assembly according claim 1 characterized in that the pivot movement is allowed by stop end cam design in the conjunction between mirror head and mirror base.

8. A rear view mirror assembly according claim 7 characterized in that the stop end cam has a first level to stop normal fold back movement and a mean to override the first stop end level to achieve additional movement.
